(19) United States
(12) Patent Application Publication
(10) Pub. No.: US 2015/0000533 A1
(43) Pub. Date: Jan. 1, 2015

(54) APPARATUS FOR BREWING INGREDIENTS IN A SOLVENT

(71) Applicant: KONINKLIJKE PHILIPS N.V., EINDHOVEN (NL)

(72) Inventors: Wan Kei Ricky Ha, Eindhoven (NL); Guangwei Wang, Eindhoven (NL)

(21) Appl. No.: 14/364,444

(22) PCT Filed: Dec. 10, 2012
(86) PCT No.: PCT/IB2012/057120

§ 371 Date: Jun. 11, 2014

(30) Foreign Application Priority Data
Dec. 26, 2011 (CN) PCT/CN2011/084704

(51) Int. Cl. A47J 31/053; A47J 31/06

(52) U.S. Cl. CPC A47J 31/053; A47J 31/0615
USPC 99/283; 99/299

(57) ABSTRACT

The invention relates to an apparatus (APP) for preparing a beverage from a solvent (S) and ingredients (IG). The apparatus comprises: a container (CO) for containing the solvent, an infuser (IF) for containing the ingredients, and said infuser being placed in the container (CO), a system (SYS) for carrying the solvent from the container (CO) into said infuser (IF) at a given flow rate (Rin), an arrangement (AR) for carrying the solvent from said infuser (IF) into the container (CO), and for regulating the output flow rate (Rout) of said solvent to an average value corresponding to the given input inflow rate (Rin). This apparatus allows the amount of solvent inside the infuser to remain constant in order to guarantee optimal brewing of the ingredients.

### FIELD OF THE INVENTION

The invention relates to an apparatus for brewing ingredients in a solvent.

The invention may be used, for example, in the field of beverage preparation.

### BACKGROUND OF THE INVENTION

Preparing beverages by brewing (raw) ingredients in a solvent is very popular. For example, tea is prepared by brewing (i.e. infusing) tea leaves (or tea bags) used as ingredients, in hot/boiling water used as the solvent. The same process may be used when beverages are prepared from different ingredients, such as various herbs, plant leaves or plant roots.

After a given period of time, ingredients are taken out of the solvent, and the resulting solvent corresponds to the prepared beverage. Such beverages are usually prepared using dedicated domestic appliances, such as a tea maker.

To simplify the use by end-users of such appliances regarding the time the ingredients should be allowed to infuse in the solvent, some solutions have been proposed. For example, published patent EP227200A1 describes a tea maker implementing a siphon mechanism allowing to drain the infuser after a certain period of time, without any user action. However, such a solution has some limitations, because if a higher input flow rate or a continuous input flow rate of the solvent in the infuser is used, for example to accelerate the brewing of ingredients, the infuser will easily overflow because the siphon mechanism cannot absorb such a high input flow rate of solvent, resulting in a non-optimal brewing process.

### OBJECT AND SUMMARY OF THE INVENTION

It is an object of the invention to propose an improved apparatus for preparing a beverage from a solvent and ingredients. The invention is defined by the independent claims. The dependent claims define advantageous embodiments.

To this end, the apparatus according to the invention is characterized in that it comprises:

a container for containing said solvent,

an infuser for containing said ingredients, and said infuser being placed in said container,

a system for carrying said solvent from said container into said infuser at a given flow rate,

an arrangement for carrying the solvent from said infuser into said container, and for regulating the output flow rate of said solvent to an average value corresponding to said given input inflow rate.

This apparatus not only allows the solvent to circulate from the infuser back to the container, but also regulates the output flow rate Rout of the solvent exiting the infuser and flowing back into the container. Thus, the solvent in the infuser leaves the infuser in a controllable way via the arrangement, ensuring that the solvent in the infuser will not overflow at the upper part of the infuser, even if the input flow rate of solvent into the infuser fluctuates. In other words, the arrangement AR allows the amount of solvent inside the infuser to remain constant in order to guarantee optimal brewing of the ingredients.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 depicts an apparatus according to the invention for preparing a beverage from a solvent and ingredients,

FIGS. 2A-2B depict a first type of implementation for an arrangement according to the invention,

FIGS. 3A-3B illustrate two positions of a cap element according to the invention,

FIGS. 3C-3D illustrate two positions of a cap element according to the invention,

FIGS. 4A-4B-4C-4D depict different views of the setup and operation of an arrangement according to the invention,

FIGS. 5A-5B depict two implementations of an improved cap element according to the invention,

FIGS. 6A-6B depict a second embodiment according to the invention,

FIG. 7 depicts a second type of implementation for the arrangement AR according to the invention,

FIG. 8 depicts an apparatus according to the invention for preparing a beverage from a solvent and ingredients.

### DETAILED DESCRIPTION OF THE INVENTION

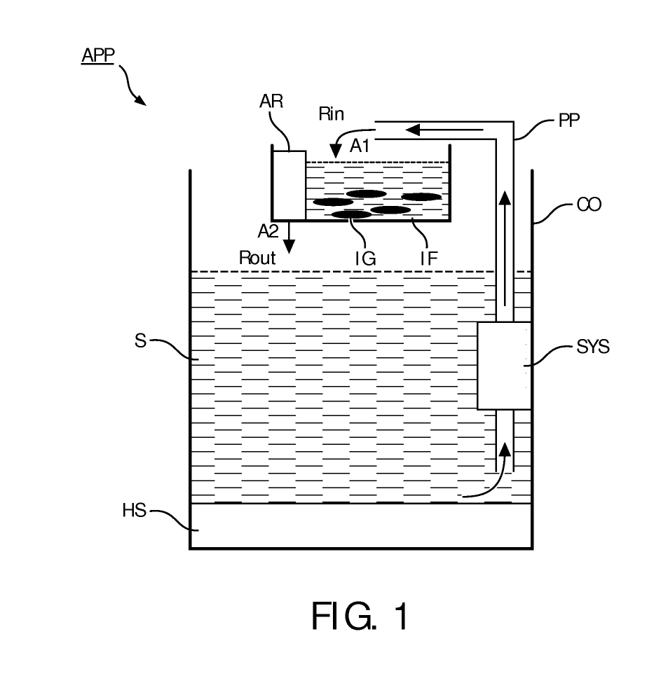

FIG. 1 depicts an apparatus APP according to the invention for preparing a beverage from a solvent S and ingredients IG. The apparatus APP comprises:

a container CO for containing the solvent,

an infuser IF for containing the ingredients, and said infuser being placed in the container CO,

a system SYS for carrying the solvent from the container CO into the infuser IF at a given input flow rate Rin,

an arrangement AR for carrying the solvent from the infuser IF to the container CO, and for regulating the output flow rate Rout of said solvent to an average value corresponding to said given input inflow rate Rin.

The ingredients IG may correspond, for example, to any type of tea leaves, coffee, herbs, roots, fruits, or a mix of those ingredients.

The solvent may correspond, for example, to water, mineral water, tap water, salted water, alcohol, or a mix of those solvents.

Advantageously, the apparatus comprises a heating system HS placed at the bottom part of the container to heat the solvent.

If the apparatus according to the invention falls in the home-appliances category, the input flow rate Rin is typically in the range of 0 to 1.0 L/min.
If the apparatus according to the invention falls in the semi-professional or professional category, the input flow rate Rin is typically in the range of 0 to 10.0 L/min

The infuser IF is placed in the container CO, and is for example fixed in the top part of container CO by legs or equivalent (not shown) extending from the container's wall to the infuser. The system SYS is used to circulate the solvent S from the lower part of container CO to the upper part of the infuser IF, via a pipe PP.

The system SYS corresponds, for example, to an electrical fluid pump.

Alternatively, as depicted in FIG. 8, the system SYS corresponds to a pumping mechanism based on percolation effect, and comprises:

a tube TT placed in the container, the tube TT having a first extremity EX1 placed at the proximity of a bottom part BP of the container CO, and a second extremity EX2 reaching the infuser IF, and

an air pump AP for generating an air flow exiting at said bottom part BP and entering the tube at the first extremity EX1, for carrying the solvent in the tube TT from the first extremity EX1 to the second extremity EX2.

The air flow is illustrated by white circles in the solvent S, under the first extremity EX1. The air pump AP may be of any type, but is preferably a diaphragm air pump. Air is pumped from outside the container. It is appreciated that the tube TT preferably extends vertically, so as to facilitate the movement of the air flow and the solvent therein. However, the tube TT may also be such that its main axis departs from the vertical direction, for example by an angle between 0 and 45 degrees. Also, the tube TT is preferably cylindrical-shaped, but may also have different shapes, such as a corkscrew-shape, or a curved-shape. The tube TT advantageously has an average diameter between 5 and 7 millimeters, or an average sectional area between 19.6 and 38.5 square millimeters. Advantageously, as illustrated, the first extremity EX1 of tube TT has a funnel-shaped entrance so that an air flow generated by the air pump AP more easily enters the tube TT. If the apparatus according to the invention falls within the home-appliances category, the air pump AP advantageously generates an air flow between 1 and 2 liters per minute, and the pumping is efficient if at least 80% of this air flow enters the tube at the first extremity EX1. If the apparatus according to the invention falls within the semi-professional or professional category, the air pump AP advantageously generates an air flow between 10 and 20 liters per minute, and the pumping is efficient if at least 80% of this air flow enters the tube at the first extremity EX1. By generating an air flow by means of the air pump instead of vapor bubbles naturally generated by locally boiling water, as is the case with a conventional percolator, the solvent can reach the upper part of the tube TT while having a temperature much below the boiling temperature of the solvent, so that the temperature of the solvent can be adapted to the ingredients used in the brewing process. Preferably, if a heating system HS is installed in the bottom part of the container, the heating power of the heating element is such that the solvent is heated to a temperature in excess of 60 degrees Centigrade, so as to improve the pumping effect in the tube TT.

Alternatively, the system SYS corresponds to a pumping mechanism driven by steam (not shown) generated after heating the solvent in the container.

The solvent leaving the pipe PP, as illustrated by arrows A1, drops into infuser IF at a given input flow rate Rin. The solvent in the infuser IF then drops back into container CO via the arrangement AR at an output flow rate Rout, as illustrated by arrows A2. Circulating the solvent from the container CO into the pipe PP, then infusing the ingredients in the infuser IF in the solvent contained in the infuser, and subsequently the solvent in the infuser dropping back into the container, constitute a closed brewing cycle that is continued until the brewing process is stopped. The brewing process is stopped based on a preset duration or an end-user time preference, but as this aspect is not part of the present invention, it will not be further detailed here.

The arrangement AR not only allows the solvent to circulate from the infuser back to the container, but also regulates the output flow rate Rout of the solvent exiting the infuser and flowing back to the container, as will be further detailed in the following. Thus, the solvent in the infuser leaves the infuser in a controllable way via the arrangement AR, ensuring that the solvent in the infuser will not overflow at the upper part of the infuser, even if the input flow rate Rin of solvent in the infuser fluctuates. In other words, the arrangement AR allows the amount of solvent inside the infuser to remain constant to guarantee optimal brewing of the ingredients.

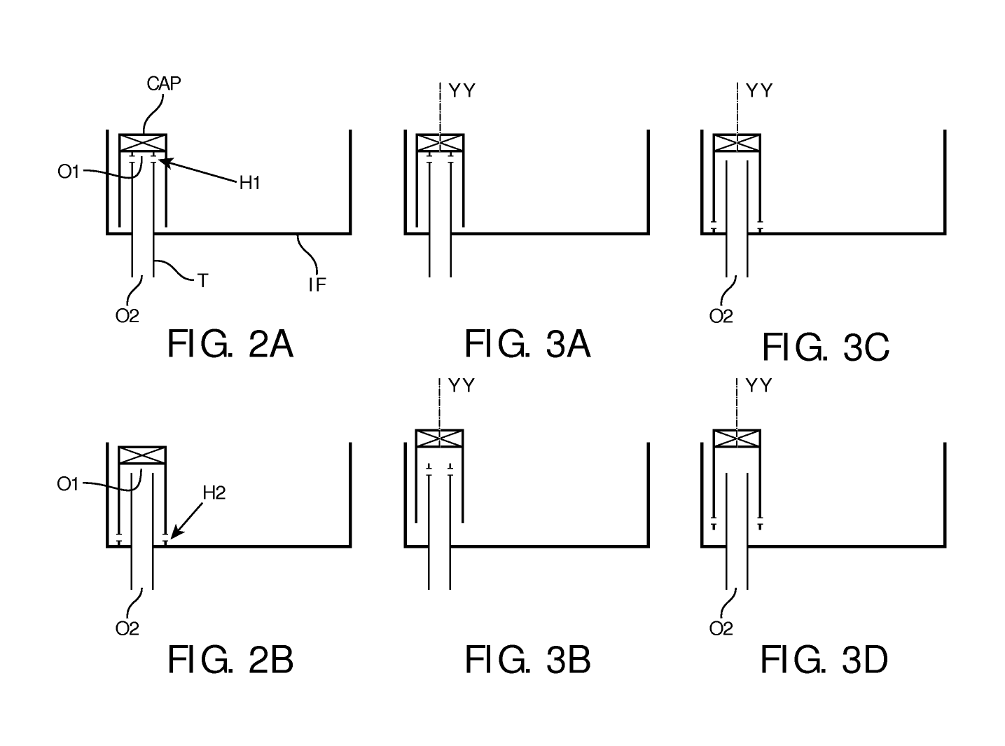

FIGS. 2A-2B depict a first type of implementation of the arrangement AR according to the invention. The arrangement AR comprises a tube T extending through the bottom part of the infuser IF. The tube T has a first opening O1 inside the infuser IF and a second opening O2 outside the infuser emerging in the container CO. The arrangement AR also comprises a cap element CAP cooperating with the tube T to obstruct the first opening O1, depending on the height of the solvent S in the infuser IF.

Advantageously, the tube T has a circular section, and the cap element is cylindrically shaped. Advantageously, the cap element is made of food-grade material, preferably heat-resistant.

According to a first embodiment of the first type of implementation of the arrangement AR, the cap element comprises a float F attached to its top, to allow the cap element CAP to obstruct the first opening O1 depending on the height of the solvent in the infuser IF. Alternatively, the float F can be attached to a side or other parts of the cap element (not shown).

The float is made of any material having a density lower than that of the solvent. Alternatively, the float can comprise an empty cavity (vacuumed, or filled with air or other gasses).

The cap element CAP is adapted to allow the solvent in the infuser to freely enter the inside cavity of the cap element, independently of the position of the cap element. To this end two implementations are proposed:

According to a first implementation illustrated in FIG. 2A, the top part of the cap element leans on the first opening O1, and the length of the inside cavity of the cap element is shorter than the length of the tube between the first opening O1 and the bottom part of the infuser. In this case, as will be better understood in the following, the tube T also comprises at least one opening at its top part near the first opening O1, such as holes H1 formed in the walls of the tube. The opening at the top part of the tube T near the first opening O1 is such that the output flow rate Rout=Rout_min through this opening should be smaller than the input flow rate Rin. This condition can for example be fulfilled by determining the diameter of holes H1 for the range of input flow rates Rin considered, for example via a preliminary calibration.

According to a second implementation illustrated in FIG. 2B, the bottom part of the cap element leans on the bottom part of the infuser, and comprises at least one opening at its bottom part, such as holes H2 formed in the walls of the cap element. In this case, as will be better understood in the following, the length of the inside cavity of the cap element is slightly longer than the length of the tube between the bottom part of the infuser and the first opening O1, to ensure a minimum gap between the top part of the cap element and the first opening O1. The minimum gap between the top part of the cap element and the first opening O1 is such that the output flow rate Rout=Rout_min through this minimum gap should be smaller than the input flow rate Rin. This condition can for example be fulfilled by determining a suitable distance between the top part of the cap element and the first opening O1 for the range of input flow rates Rin considered, for example via a preliminary calibration.

FIGS. 3A-3B illustrate two positions of the cap element according to the invention. The cap element corresponds to the cap element as depicted in FIG. 2A. The cap element CAP freely cooperates with the tube T via translation along a vertical direction YY. When the cap element CAP is in the position as illustrated in FIG. 3A, the top part of the cap element obstructs the first opening O1, defining a minimum gap between the top part of the cap element and the first opening O1. When the cap element CAP is in the position as illustrated in FIG. 3B, the top part of the cap element uncovers the first opening O1, defining a larger gap between the top part of the cap element and the first opening O1.

FIGS. 3C-3D illustrate two positions of the cap element according to the invention. The cap element corresponds to the cap element as depicted in FIG. 2B. The cap element CAP freely cooperates with the tube T via translation along a vertical direction YY. When the cap element CAP is in the position as illustrated in FIG. 3C, the top part of the cap element obstructs the first opening O1, defining a minimum gap between the top part of the cap element and the first opening O1. When the cap element CAP is in the position as illustrated in FIG. 3D, the top part of the cap element uncovers the first opening O1, defining a larger gap between the top part of the cap element and the first opening O1.

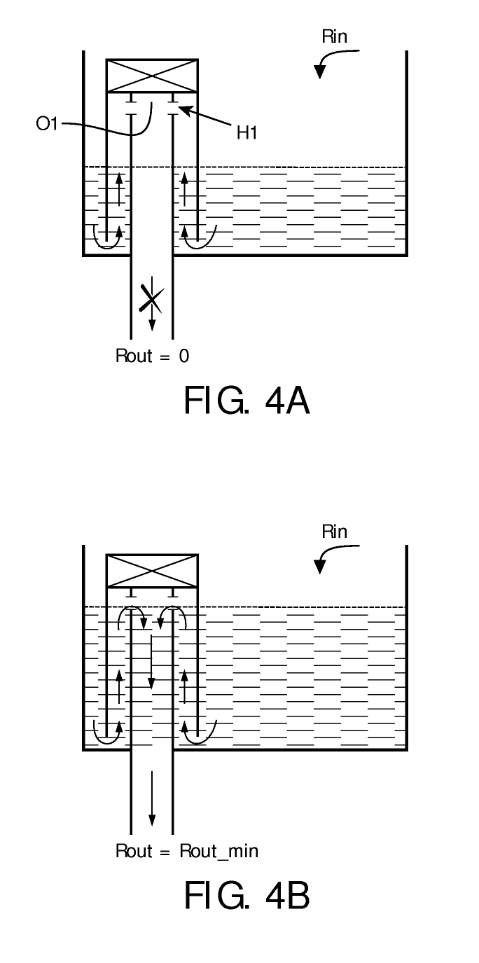

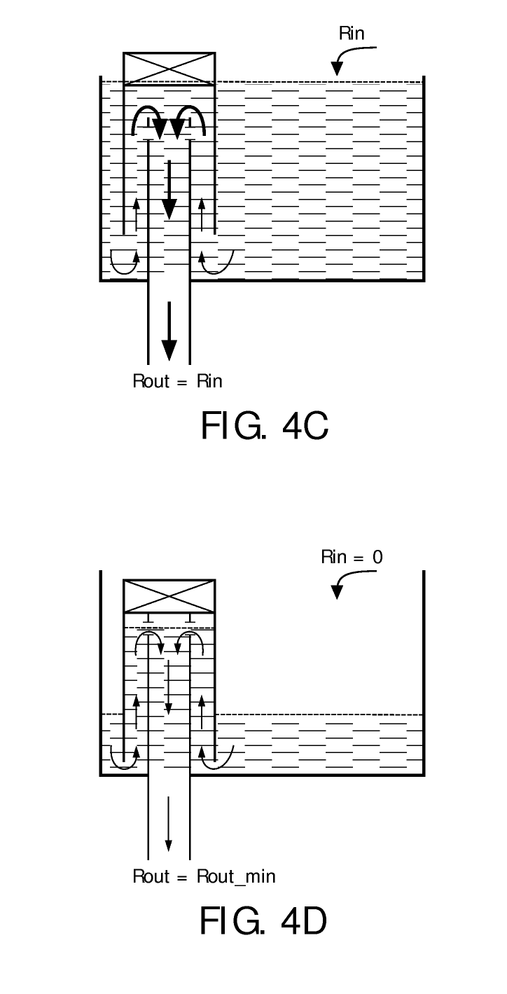

FIGS. 4A-4B-4C-4D depict different views of the setup and operation of the arrangement AR according to the invention, which will be explained based on an arrangement AR according to FIG. 2A, but which could similarly be explained based on an arrangement AR according to FIG. 2B.

In FIG. 4A, which corresponds to the start of the brewing process, the solvent is introduced into the infuser at a given input flow rate Rin. Solvent enters the inside cavity of the cap element via the bottom part thereof, and then rises inside the cavity.

In FIG. 4B, as soon as the solvent level reaches the first opening O1, the solvent starts to exit via the holes H1 at an output flow rate Rout=Rout_min through the second opening O2.

In FIG. 4C, since Rout_min<Rin, the solvent continues to rise in the infuser up to the bottom part of the float F. As the solvent continues to rise inside the infuser, the float F facilitates the upward movement of the cap element. The higher the vertical position of the cap element, the larger the gap between the top part of the cap element and the first opening O1 is. As the gap between the top part of the cap element and the first opening O1 increases, solvent can exit at a higher flow rate via the tube T to the second opening O2. The cap element thus moves upwards until it reaches an equilibrium for which the gap between the top part of the cap element and the first opening O1 is large enough to evacuate, via the second opening O2, all the additional quantity of solvent introduced into the infuser at an input flow rate Rin. When this equilibrium is reached, the average value of the output flow rate Rout is thus equal to the input flow rate Rin. This equilibrium condition is continued as long as the brewing of ingredients is not terminated.

In FIG. 4D, which corresponds to the end of the brewing process, the input flow rate Rin is set to 0. As a result, the level of the solvent in the infuser starts to decrease, while the output flow rate varies from Rout=Rin to Rout=Rout_min as soon as the cap element has reached its initial position as shown in FIG. 4A. Then, since the cap element and the exit tube T form a siphon assembly, the remaining solvent in the infuser is totally drained from the infuser to the container at an output flow rate Rout=Rout_min.

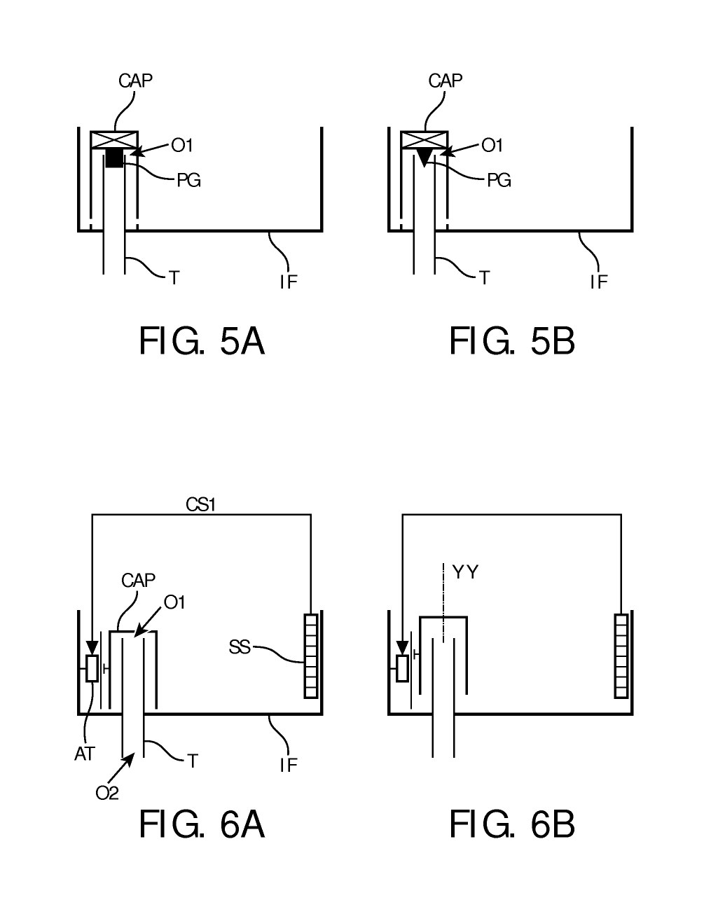

FIGS. 5A-5B depict two implementations of an improved cap element CAP according to the invention. The cap element additionally comprises a plug PG cooperating with the first opening O1. The plug facilitates partial obstruction of the first opening O1 when the cap element is in a position in which the level of solvent in the infuser is low enough. The plug can be cylindrically shaped, as illustrated in FIG. 5A. Alternatively, the plug can be conically shaped, as illustrated in FIG. 8B. A conically shaped plug is advantageous for the reason that it results in a smoother change in the opening of the first opening O1 when the cap element moves upwards as the solvent in the infuser is rising, which allows a smoother regulation of the output flow rate Rout.

According to a second embodiment of the arrangement AR according to the invention, as illustrated in FIGS. 6A-6B, the arrangement AR further comprises an actuator AT for moving the cap element CAP along said tube T, based on a control signal CS1 reflecting the level of solvent in the infuser. According to this embodiment, the cap does not comprise a float anymore, and the upward movement of the cap element takes place via the actuator AT instead. To this end, the apparatus according to the invention comprises a sensor SS placed in the infuser, to generate a control signal CS1 indicating the level of solvent in the infuser. This control signal CS1 is used by the actuator AT to move the cap element upwards or downwards to enlarge the gap to a greater or smaller extent between the top part of the cap element CAP and the first opening O1, with a view to maintaining a given level of solvent in the infuser. FIG. 6A illustrates the situation where the actuator maintains a minimum gap between the top part of the cap element CAP and the first opening O1, and FIG. 6B illustrates the situation where the actuator maintains a larger gap between the top part of the cap element CAP and the first opening O1. The actuator corresponds for example to a linear motor, or any other actuator adapted to cause the cap element CAP to perform a translatory motion along vertical axis YY. The sensor SS corresponds for example to a resistor-based sensor delivering a voltage signal proportional to the level of solvent in the infuser.

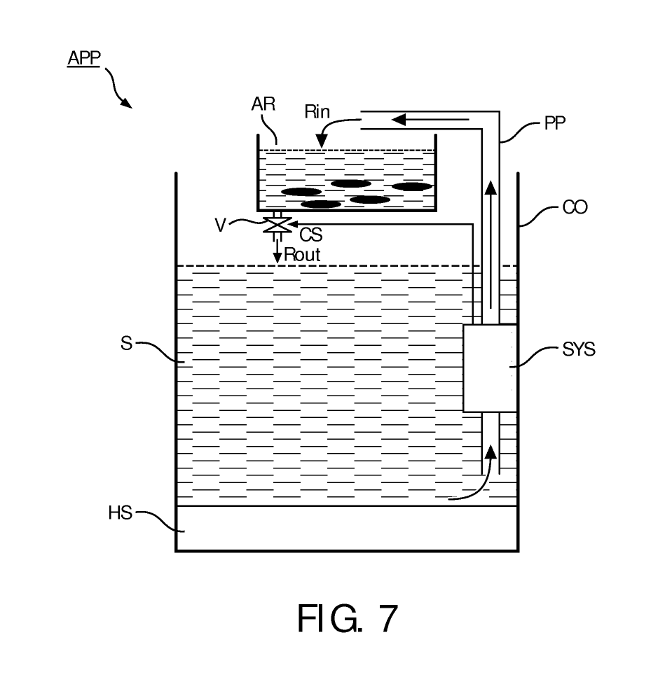

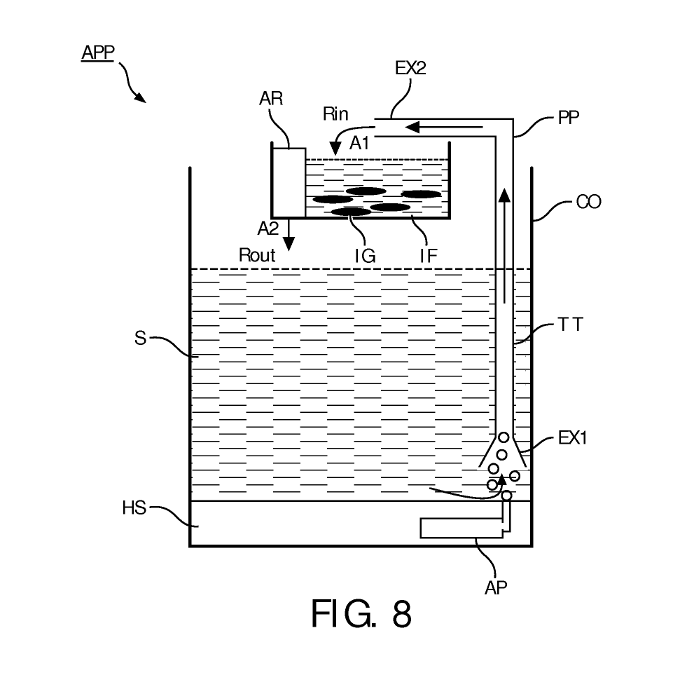

FIG. 7 depicts a second type of implementation of the arrangement AR according to the invention. The arrangement AR comprises a valve V extending through the bottom part of the infuser IF. The valve has a section varying as a function of a control signal CS2 reflecting the value of the input flow rate Rin. The valve is electrically controlled by the control signal CS2. The larger the section of the valve, the higher the output flow rate Rout. Through preliminary calibration, for each given value of the input flow rate Rin, it is possible to determine the corresponding section of the valve necessary to ensure an output flow rate equal to the input flow rate Rin. Thus, after brewing has started and the solvent has reached a predetermined level in the infuser, the valve is opened in a dynamic way to match the given input flow rate Rin, ensuring that the solvent in the infuser will not overflow. Alternatively, the valve has a section varying as a function of a control signal CS2 reflecting the level of solvent in the infuser. To this end, a sensor such as sensor SS described in FIG. 6A-6B can be used.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single unit may fulfill the functions of several items recited in the claims. The mere fact that certain measures are recited in mutually different dependent claims does not indicate that a combination of these measures cannot be used to advantage. Any reference sign in the claims should not be construed as limiting the scope.

1. Apparatus for preparing a beverage from a solvent and ingredients, said apparatus comprising:
a container for containing said solvent,
an infuser for containing said ingredients, and said infuser being placed in said container,
a system for carrying said solvent from said container into said infuser at a given input flow rate,
an arrangement for carrying the solvent from said infuser into said container, and for regulating the output flow rate of said sol to average value corresponding to said given input flow rate, wherein arrangement comprises:
a tub extending through the bottom part of the infuser, said tube having a first opening inside the infuser and a second opening outside the infuser emerging in said container,
a cap element cooperating with said tube to obstruct said first opening, depending on the height of solvent in the infuser.

2. (canceled)

3. Apparatus as claimed in claim 1, wherein said cap element comprises a float.

4. Apparatus as claimed in claim 3, wherein said cap element further comprises a plug cooperating with said first opening.

5. Apparatus as claimed in claim 4, wherein said plug is cylindrically shaped.

6. Apparatus as claimed in claim 4, wherein said plug is conically shaped.

7. Apparatus as claimed in claim 2, wherein said arrangement further comprises an actuator for moving the cap element along said tube, based on a control signal reflecting the level of solvent in the infuser.

8. Apparatus as claimed in claim 1, wherein said arrangement comprises a valve extending through the bottom part of the infuser, said valve having a section varying as a function of a control signal reflecting the value of the input flow rate.

9. Apparatus as claimed in claim 1, wherein said system is a fluid pump.

10. Apparatus as claimed in claim 1, wherein said system is a pumping mechanism based on percolation effect.
